(19) United States
(12) Patent Application Publication
(10) Pub. No.: US 2010/0082390 A1
(43) Pub. Date: Apr. 1, 2010

(54) DIGITAL DASHBOARD REPORTING SYSTEM AND METHOD OF USE

(76) Inventors: John W. Adams, JR., Houston, TX (US); Tobin S. Lassen, Houston, TX (US)

Correspondence Address: Houston IP Department;JACKSON WALKER L.L.P., 1401 McKinney St., Suite 1900, Houston, TX, 77010, US

(21) Appl. No.: 12/570,826

(22) Filed: Sep. 30, 2009

Related U.S. Application Data
(60) Provisional application No. 61/194,759, filed on Sep. 30, 2008.

(51) Int. Cl. G06Q 10/00

(52) U.S. Cl. 705/7

(57) ABSTRACT

A reporting system for displaying to a user a plurality of key financial performance metrics about a practice, said reporting system comprising one or more user computers, each of said user computers having a practice digital dashboard for displaying said plurality of key financial performance metrics, wherein said practice digital dashboard includes one or more selectable data analysis interfaces to present said plurality of key financial performance metrics in a grid of one or more tables, graphs, or charts; one or more data servers in communication with each of the user computers, each data server comprising a set of billing and collection information for said practice and one or more functions for computing said plurality of key financial performance metrics from said set of billing and collection information for said practice; and a network allowing communication between said one or more user computers and said one or more data servers.

This application claims the benefit of priority of U.S. Provisional Application No. 61/194,759, filed Sep. 30, 2008.

### FIELD OF THE INVENTION

This invention relates to the field of computer systems, and in particular to an improved electronic reporting tool within a practice reporting system.

### BACKGROUND OF THE INVENTION

The health care industry in the United States generally follows a standardized process for providing services to patients and compensating providers for the services rendered. The process begins when a patient sees a provider, who renders one or more medical services to the patient. The provider is usually compensated for those services in one of two ways. In the first, the patient pays (or has already paid) the provider at the time of service in full for the services provided, usually out-of-pocket. In the second, the patient makes a small co-payment (or sometimes no co-payment) to the provider, who subsequently submits claims to the patient's insurer (either private or government) for the full cost of the services rendered. After the providers submit claims to the insurers for services provided, the insurers will either pay or deny the claims. Payments from the insurers often include adjustments based on the rates contracted between the insurer and the provider. A denial may occur for a variety of reasons, including but not limited to a lack of coverage, a lack of authorization, submitting claims past the claim deadline, and rendering non-medically necessary services.

The great majority of Americans obtain health care services either under private insurance companies or government insurance programs (i.e. Medicare, Medicaid, and other state and local insurance programs). However, each insurer generally utilizes a different billing and collection process, resulting in a highly complicated system of billing and collection with very little standardization. Consequently, a well-managed billing and collection process is of primary importance to providers. Over the past few decades, medical billing has gradually shifted from a predominantly paper-based system to a predominantly electronic system. Thus, a wide variety of electronic medical billing systems exist today to assist providers in submitting and tracking electronic claims.

Practice reporting systems and in particular, reporting tools, allow a provider to evaluate the overall financial status of his or her practice. Although a variety of electronic medical billing systems exist, these systems often do not incorporate sophisticated reporting tools for providers. For those electronic medical billing systems that do offer practice reporting tools to providers, the reporting tools are often inadequate for providers' needs. The inadequacy may arise from a number of sources, such as providing inappropriate metrics or supplying information in a format that is difficult or time-consuming for providers to interpret and utilize. Thus, there exists a strong need for a reporting tool that supplies a provider with meaningful, direct indicators of the practice's financial health in a way that is clear.

In one embodiment, the present invention provides an improved reporting system providing suitable tools for monitoring the financial status of a practice, in particular tools that supply financial information about the overall financial state of the practice.

Another embodiment of the present invention provides financial information about the overall financial state of the practice in a user-friendly format called a practice digital dashboard.

### BRIEF SUMMARY OF THE INVENTION

The present invention relates to a reporting system which may allow a user to display key financial indicators about a practice in real-time, including performance indicators for charges, payments, adjustments, denials, comparisons, and reports. The key financial indicators may be displayed in convenient graph, chart and table formats.

### BRIEF DESCRIPTION OF THE DRAWINGS

FIG. 1 shows a reporting system in an embodiment of the present invention;

FIG. 2 shows a charge analysis interface in a dashboard application in an embodiment of the present invention;

FIG. 3 shows a payment analysis interface in a practice dashboard application in an embodiment of the present invention;

FIG. 4 shows an adjustment interface in a practice dashboard application in an embodiment of the present invention;

FIG. 5 shows a denials interface in a practice dashboard application in an embodiment of the present invention;

### DETAILED DESCRIPTION OF THE INVENTION

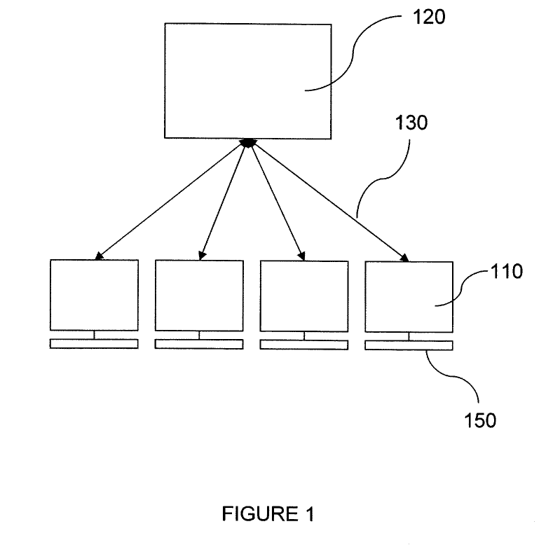

The present invention relates to an improved reporting system called a practice digital dashboard. FIG. 1 shows an embodiment of the reporting system, including one or more user computers 110, one or more data servers 120, a secure Internet connection 130, practice data, and a practice dashboard application 150. The practice digital dashboard application 150 may include a plurality of data analysis interfaces, each data analysis interface may display multiple performance indicators computed from practice data. In accordance with the present invention, a user may utilize user computer 110 to connect to data server 120 through secure Internet connection 130 and, utilizing practice dashboard 150, view and interact with data analysis interfaces displaying performance indicators.

In an embodiment of the invention, user computers 110 may be located at the offices of a healthcare provider, and a user may be a healthcare provider, an employee, manager, officer, director, or partner of healthcare provider. Alternatively, user computers 110 may be located anywhere that Internet access is available, such as at the home of user or at a local coffee shop, since the user computers 110 connect to the data servers 120 through an Internet link. Likewise, the data servers 120 may be located in an offsite location, such as a third party data center, at the offices of healthcare provider, or at any other location with Internet access.

In an embodiment of the invention, a secure Internet connection 130 between the user computers 110 and the data servers 120 may be established through the Transport Layer Security (TLS) or Secure Socket Layer (SSL) of the Internet. In addition, one of ordinary skill in the art will recognize that any number of standard encrypted Internet protocols may form secure Internet connection 130.

In accordance with the invention, a healthcare provider may be an individual medical practitioner, individual dental practitioner, or some other individual practitioner in the health care industry. Health care provider also encompasses a group of individual practitioners, such as a hospital, outpatient clinic, or an office practice.

In accordance with the invention, practice data may include billing and collection information of health care provider, such as practitioner billing charges, dates of billing, payments, dates of payments, denials, dates of denials, bases for denials, adjustments, dates of adjustments, bases for adjustments, and Current Procedural Terminology (“CPT”) coding information. Practice data may also include other billing and collection information of healthcare provider. In a preferred embodiment, practice data is stored in an electronic database resident on data server 120. Practice data may be automatically generated from an electronic medical billing system, or may be created via manual input of the data.

In an embodiment of the invention, a secure Internet connection 130 is established to data servers 120, and the user may employ practice digital dashboard 150 to view key financial metrics or performance indicators in data analysis interfaces. Performance indicators may be computed from practice data by data servers 120 and displayed in convenient table, chart, text, and graph formats in data analysis interfaces. In one embodiment, the performance indicators are computed “on demand” when the user makes a request to view a data analysis interface. In another embodiment, the performance indicators are computed and stored with practice data on data servers 120 whenever practice data is created or updated.

In an embodiment of the invention, a practice digital dashboard application 150 displays performance indicators in data analysis interfaces, allowing user to track trending, establish cash goals, and monitor the daily practice financials. The practice digital dashboard 150 may include one or more data analysis interfaces, including a charge analysis interface 310, a payment analysis interface 320, an adjustment interface 330, a denials interface 340, a comparison interface, and a report creation interface. User selects the particular data analysis interface through practice digital dashboard 150.

The performance indicators are created by applying an algorithm or function to practice data. Functions may include a summation function which sums a set of numbers, an averaging function which computes the mean of set of numbers, a sorting or ranking function which sorts or ranks a set of data, and a simple division function which divides one number by another. Performance indicators may be displayed as tables, pie charts, xy graphs, ring charts, or bar charts. For each performance indicator, the user may hover a mouse pointer over the performance indicator for additional information in a text box. The user may also click the mouse pointer on certain performance indicators in order to drill down into more detailed information regarding that performance indicator.

Each data analysis interface allows practice data to be partitioned into practice data partitions or sets based on criteria selected by user. Criteria include date of service, medical specialty, location, and practitioner or practitioner group. User selects the applicable partitioning criteria in the data analysis interface, and may partition practice data using multiple criteria. Functions may then be applied to the practice data sets to generate performance indicators.

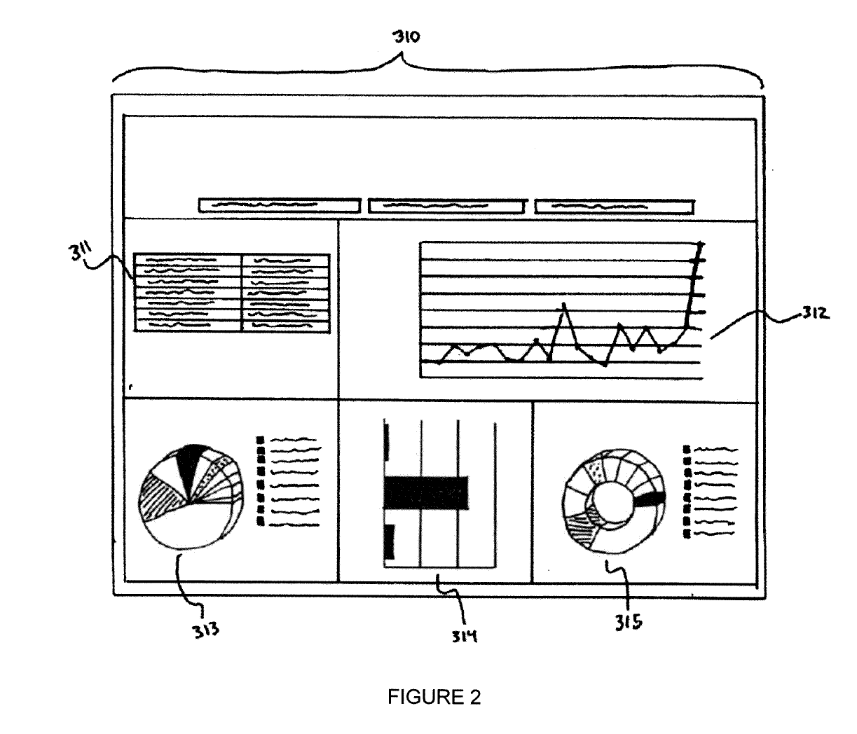

Turning to the data analysis interfaces, in an exemplary embodiment of the invention, a charge analysis interface 310 includes five performance indicators, shown in FIG. 2. A summary table 311 displays summary information about practice data (or practice data sets), including charges, payments, adjustments, denials, gross collection percentage, net collection percentage, and days in accounts-receivable. A charges-by-day xy graph 312 displays charge information over a range of dates. A top-10-charges-by-carrier pie chart 313 displays charge information ranked by carrier. A charges-by-place-of-service bar chart 314 displays charge information categorized by the place where the service was performed. Finally, a top-10-charges-by-CPT-code ring chart 315 displays charge information ranked by CPT code.

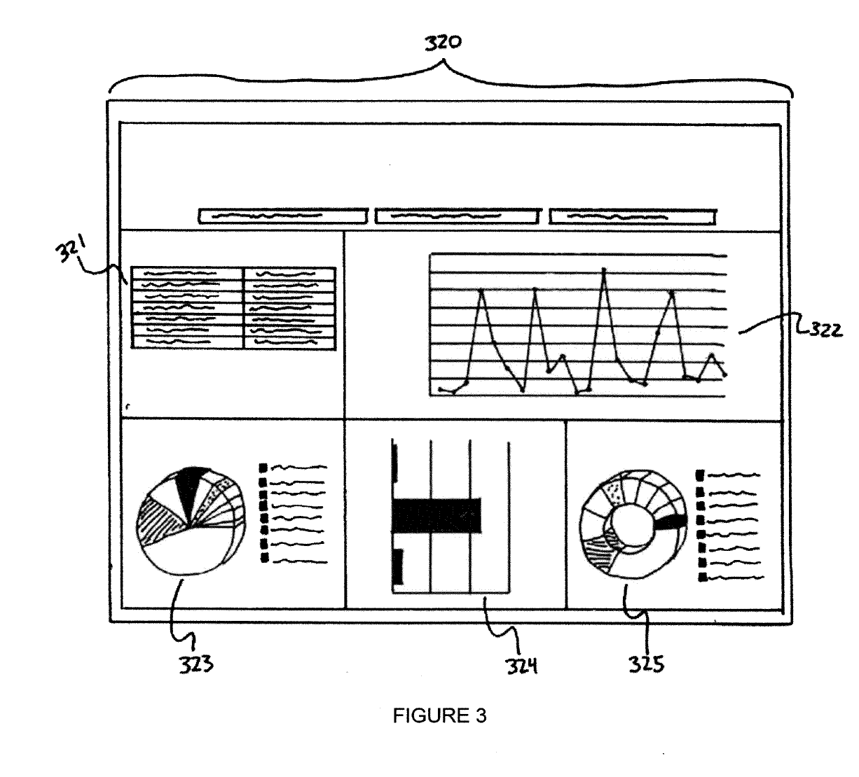

In a further exemplary embodiment of the invention, a payment analysis interface 320 includes five performance indicators as shown in FIG. 3. A summary table 321 displays summary information about practice data (or practice data sets), including charges, payments, adjustments, denials, gross collection percentage, net collection percentage, and days in accounts-receivable. A payments-by-day xy graph 322 displays payment information over a range of dates. A top-10-payments-by-carrier pie chart 323 displays payment information ranked by carrier. A payments-by-place-of-service bar chart 324 displays payment information categorized by the place where the service was performed. Finally, a top-10-payments-by-CPT-code ring chart 325 displays payment information ranked by CPT code.

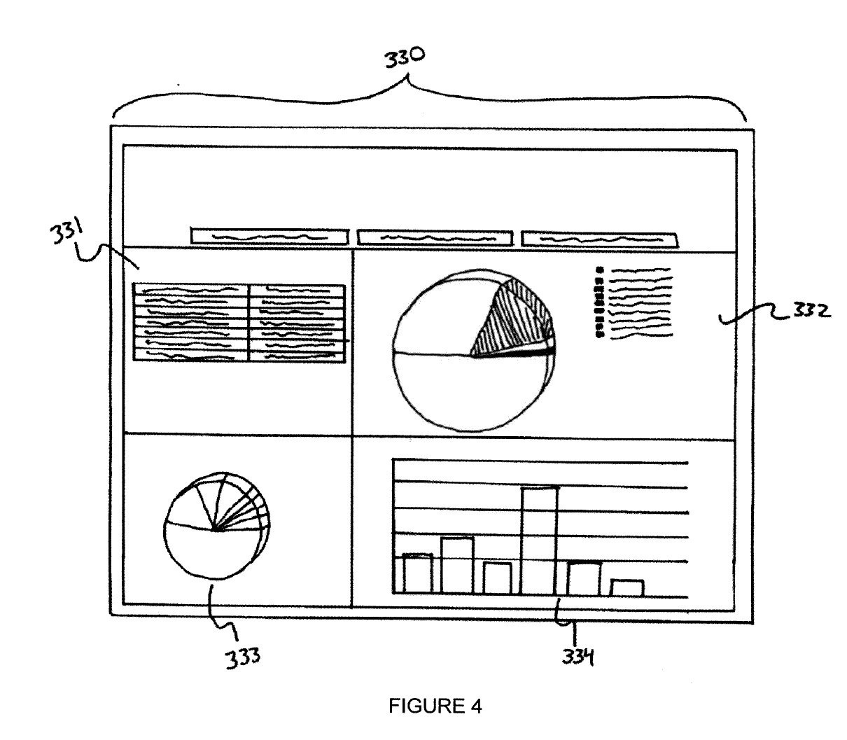

In an exemplary embodiment of the invention, an adjustment interface 330 includes a plurality of performance indicators as shown in FIG. 4. A summary table 331 displays summary information about practice data (or practice data sets), including charges, payments, adjustments, denials, gross collection percentage, net collection percentage, and days in accounts-receivable. An overall-adjustments pie chart 332 displays adjustment information categorized by adjustment basis. An adjustments-by-CPT-code-summary pie chart 333 displays adjustment information categorized by CPT code. Finally, an adjustments-by-CPT-code bar chart 334 displays adjustment information categorized by CPT code.

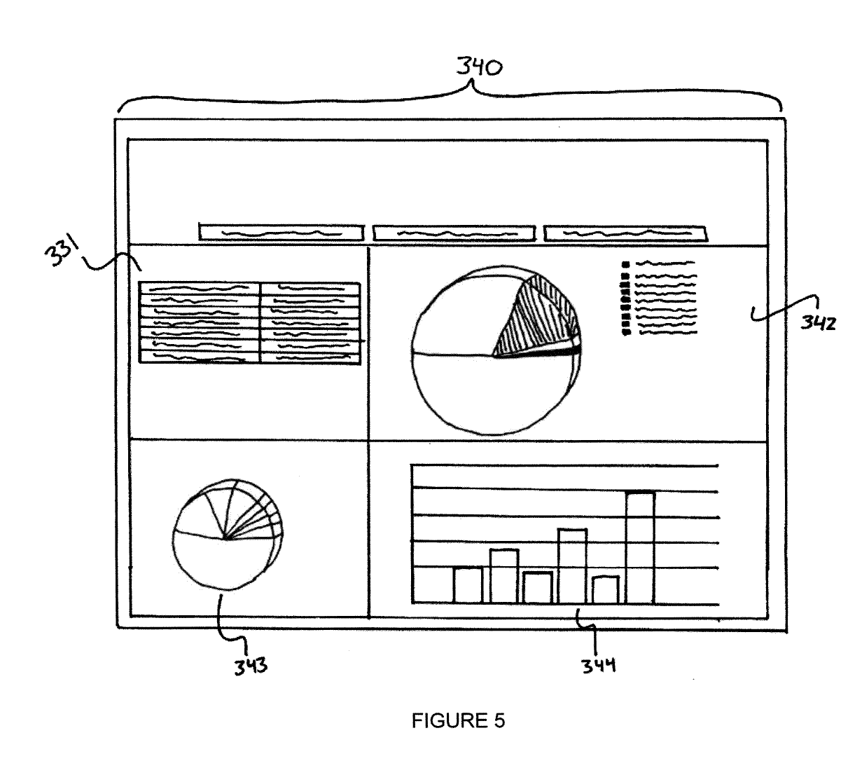

In an exemplary embodiment of the invention, a denials interface 340 includes a plurality of performance indicators as shown in FIG. 5. A summary table 331 displays summary information about practice data (or practice data sets), including charges, payments, adjustments, denials, gross collection percentage, net collection percentage, and days in accounts-receivable. An overall-denials pie chart 342 displays denial information categorized by denial basis. A denials-by-CPT-code-summary pie chart 343 displays denial information categorized by CPT code. Finally, a denials-by-CPT-code bar chart 344 displays denial information categorized by CPT code.

In a further preferred embodiment, a comparison interface includes one performance indicator. A table displays a comparison of performance during a time period in the current year to performance during the same time period in the previous year. Table provides comparison information about charges, payments, adjustments, denials, gross collection percentage, net collection percentage, and days in accounts-receivable.

Finally, in a preferred embodiment, a report creation interface displays a list of report tools that user can utilize to generate reports. Reports are created by applying one or more functions to practice data (or practice data sets). The reports may be exported in Word, Excel, XML or PDF formats. The reports also may be saved directly to user computer 110, data server, or sent via e-mail.

Although the invention has been described with reference to a specific embodiment, this description is not meant to be construed in a limiting sense. On the contrary, various modifications of the disclosed embodiments will become apparent to those skilled in the art upon reference to the description of the invention. It is therefore contemplated that the appended claims will cover such modifications, alternatives, and equivalents that fall within the true spirit and scope of the invention.

1. A reporting system for providing practice data to a user, comprising:
a) a data server, wherein the data server is capable of storing practice data, and wherein the data server is capable of computing performance indicators from the practice data;
b) a user computer, wherein the data server is in communication with a user computer via a secure internet connection;
c) a practice digital dashboard application, wherein the practice digital dashboard application is capable of running on the user computer, and wherein the practice digital dashboard application is capable of displaying performance indicators.

2. The system of claim 1, wherein the practice digital dashboard application is capable of receiving a request from a user and transmitting the request to the data server via the secure internet connection.

3. The system of claim 1, wherein the practice digital dashboard application is capable of receiving practice data from a user and transmitting the practice data to the data server via the secure internet connection.

4. The system of claim 1, wherein the data server is capable of transmitting performance indicators to the user computer via the secure internet connection.

5. The system of claim 4, wherein the performance indicators are displayed using the practice digital dashboard application.

6. The system of claim 1, wherein the data server is capable of receiving practice data from the user computer.

7. The system of claim 6, wherein the practice data is selected from the group consisting of: practitioner billing charges, dates of billing, payments, dates of payments, denials, dates of denials, bases for denials, adjustments, dates of adjustments, bases for adjustments, and Current Procedural Terminology (“CPT”) coding information.

8. A method for providing data to a plurality of users, comprising the steps of:
a) receiving a request from a user computer, wherein the request has been entered through a practice digital dashboard application running on a user computer;
b) transmitting the request to a data server, wherein the data server stores a set of practice data for the user, and wherein the data server is capable of computing performance indicators from the set of practice data;
c) receiving performance indicators from the data server; and
d) transmitting the performance indicators to the user computer, wherein the practice digital dashboard application running on the user computer is capable of displaying the performance indicators.
